(19) United States
(12) Patent Application Publication
(10) Pub. No.: US 2007/0265363 A1
(43) Pub. Date: Nov. 15, 2007

(54) Foamable composition and method for making a foam material therefrom, and an architectural material made from the foam material

(76) Inventor: Tai-Long Huang, Changhua (TW)

Correspondence Address: PETERS, VERNY, JONES & SCHMITT LLP, Suite 230, 425 Sherman Avenue, Palo Alto, CA, 94306-1840, US

(21) Appl. No.: 11/434,014

(22) Filed: May 15, 2006

(51) Int. Cl. C08J 9/00

(52) U.S. Cl. 521/99

(57) ABSTRACT

A foamable composition including 100 parts by weight of a plastic material, 4 to 125 parts by weight of coal ash, and a foaming agent, is disclosed. A method for making a foam material, and an architectural material made from the foam material are also disclosed.

### BACKGROUND OF THE INVENTION

1. Field of the Invention

This invention relates to a foamable composition, more particularly to a foamable composition including a plastic material, coal ash, and a foaming agent, and to a method for making a foam material and an architectural material made from the foam material.

2. Description of the Related Art

At present, architectural materials, such as slats, upper and lower beams, a control rod, and interlocking elements of a ventilation louver or Venetian blind, are made from a plastic material, such as polyvinyl chloride (PVC). During the manufacture of such architectural materials, particles of the plastic material are mixed with an additive, such as a stabilizer, a foaming agent, a lubricant, a processing aid, a filler, a colorant, or mixtures thereof, so as to form a pre-mixture. The pre-mixture is subsequently granulated and extruded into the plastic material having a desired shape.

Although the plastic material has good processability, its manufacture, recycling or combustion tends to result in formation of poisonous gases. Especially, hydrogen chloride gas or dioxins are generated during PVC combustion. In order to avoid the environment from being polluted with the poisonous gases formed during combustion of the plastic material, it has been proposed to replace a portion of the plastic material with wood powders for manufacturing different parts of a ventilation louver or a venetian blind. However, the wood powders are expensive. In addition, extensive use of wood powders tends to result in deforestation, which is another kind of environmental concern.

Chinese patent publication CN 1047272A has proposed a plastic composite made from a composition essentially consisting of waste polyvinyl chloride and coal ash. The plastic composite thus made is merely suitable for structural materials for concrete and asphalt construction.

Therefore, there is still a need in the art to provide an economically and environmentally protective material that is suitable for the manufacture of slats, upper and lower beams, a control rod, and interlocking elements of a ventilation louver or Venetian blind.

### SUMMARY OF THE INVENTION

Therefore, the object of the present invention is to provide a foamable composition and a method for making a foam material from the foamable composition, thereby providing an economical and environmentally protective material suitable for an architectural material, especially the architectural material for manufacturing parts of a ventilation louver, a Venetian blind or other hardware.

According to one aspect of this invention, a foamable composition includes 100 parts by weight of a plastic material, 4 to 125 parts by weight of coal ash, and a foaming agent.

According to another aspect of this invention, a method for making a foam material includes mixing 100 parts by weight of a plastic material with 95 to 105 parts by weight of coal ash and a foaming agent so as to form a foamable material, granulating the foamable material, and extruding and foaming the foamable material.

According to yet another aspect of this invention, an architectural material is made from a foam material, wherein the foam material is made by mixing 100 parts by weight of a plastic material with 95 to 105 parts by weight of coal ash and a foaming agent so as to form a foamable material, granulating the foamable material, and extruding and foaming the foamable material.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a perspective view to illustrate a Venetian blind made from the preferred embodiment of a foam material according to this invention; and

FIG. 2 is a perspective view to illustrate a ventilation louver made from the preferred embodiment of a foam material according to this invention.

### DETAILED DESCRIPTION OF THE PREFERRED EMBODIMENT

The preferred embodiment of a foamable composition according to this invention includes 100 parts by weight of a plastic material, 4 to 125 parts by weight of coal ash, and a foaming agent.

Non-limiting examples of the plastic material are selected from the group consisting of polyethylene chloride, acrylate-butadiene-styrene copolymer, polystyrene, polyethylene, and combinations thereof. Preferably, the plastic material is polyethylene. The amount of the plastic material used in the foamable composition can be varied and adjusted by skilled artisans based on the type of the end products to be made from the foamable composition. When the plastic material is excessively used in the foamable composition, the purpose of reducing pollution cannot be achieved, and adverse effects on the additives can be serious. On the other hand, if the amount of the plastic material is insufficient, the coal ash cannot be completely encapsulated by the plastic material. As a result, the end products thus formed will have a coarse outer surface, and the coal ash may be easily and undesirably removed.

The coal ash used in this invention may come from any suitable source. A non-limiting example of the coal ash is bottom ash, which is a sand-like material obtained from a bottom of a coal combustion furnace of a fuel electric plant. In addition, there is no specific limitation imposed on the size of the coal ash, as long as the size of the coal ash is adequate to make the outer surface of the end product as smooth as possible. In addition, there is no specific limitation imposed on the amount of the coal ash. However, an excess amount of the coal ash can result in a coarse outer surface for the end product. On the other hand, if the amount of the coal ash is insufficient, the purpose of environmental protection cannot be achieved. Preferably, the amount of the coal ash ranges from 90 to 105 parts by weight, based on 100 parts by weight of the plastic material. Preferably, the coal ash has a mesh size less than 400 mesh. More preferably, the coal ash has a mesh size less than 500 mesh, and most preferably, the coal ash has a mesh size ranging from 500 mesh to 1-000 mesh.

The foaming agent can be any known foaming agent suitable for foaming reaction of plastic materials. Preferably, the foaming agent is an azoic foaming agent. More preferably, the foaming agent is azodicarbonamide. There is no specific limitation imposed on the amount of the foaming agent. However, an excess amount of the foaming agent can result in poor flexibility of the final product. On the other hand, if the amount of the foaming agent is insufficient, the specific gravity of the end product increases, and a lightweight product cannot be achieved. Preferably, the foaming agent is present in an a mount ranging from 0.75 to 1.25 parts by weight, based on 100 parts by weight of the plastic material.

Preferably, the foamable composition further includes a stabilizing agent in an amount ranging from 0.5 to 1.75 parts by weight, based on 100 parts by weight of the plastic material. More preferably, the stabilizing agent is in an amount ranging from 1.0 to 1.50 parts by weight. There is no specific limitation imposed on the amount of the stabilizing agent. However, an excess amount of the stabilizing agent can result in high production cost and undesired deformation of the end product. The stabilizing agent can be any known stabilizing agent useful for preventing dissociation of the plastic material. More preferably, the stabilizing agent is alkyl tin mercaptide, and most preferably, the stabilizing agent is dimethyl tin mercaptide.

Preferably, the foamable composition further includes a lubricant in an amount ranging from 0.75 to 1.25 parts by weight, based on 100 parts by weight of the plastic material. There is no specific limitation imposed on the amount of the lubricant. However, an excess amount of the lubricant has an adverse effect on foaming efficiency of the foaming agent. More preferably, the lubricant is selected from the group consisting of calcium stearate and zinc stearate.

Preferably, the foamable composition further includes a filler in an amount ranging from 3.0 to 7.0 parts by weight, based on 100 parts by weight of the plastic material. More preferably, the filler is calcium carbonate.

Preferably, the foamable composition further includes a processing aid. There is no specific limitation imposed on the amount of the processing aid. However, an excessive amount of the processing aid can result in brittle structure of the end product. More preferably, the processing aid has an amount ranging from 1.0 to 10.0 parts by weight, based on 100 parts by weight of the plastic material. Most preferably, the processing aid is in an amount ranging from 1.0 to 6.0 parts by weight. Preferably, the processing aid is an acrylic resin. More preferably, the processing aid is Kaneace PA40 (available from Kaneka Corporation, Japan).

Optionally, the foamable composition may include a dye. There is no specific limitation imposed on the amount of the dye. The species and amount of the dye can be determined based on the desired end product. Preferably, the foamable composition includes 3 to 7 parts by weight of titanium dioxide as the dye.

The preferred embodiment of a method for making a foam material according to this invention includes mixing 100 parts by weight of a plastic material with 95 to 105 parts by weight of coal ash and a foaming agent so as to form a foamable material, granulating the foamable material, and extruding and foaming the foamable material. The mixing of the plastic material with the coal ash and the foaming agent is conducted in a manner known in the art, such as mixing in a mixer. When the plastic material, the coal ash and the foaming agent are mixed in a mixer, since heat is generated during mixing of the plastic material with the coal ash and the foaming agent, the foamable material in powder form can be obtained without heating treatment. Preferably, the mixing is conducted in a mixer at a temperature ranging from 105° C. to 145° C.

Preferably, prior to the mixing of the plastic material with the coal ash and the foaming agent, the coal ash is washed to remove impurities therefrom and is subsequently sieved to obtain the proper sieve size.

The granulating of the foamable material can be conducted in any known apparatus or equipment suitable for this purpose. Preferably, the granulating is conducted at a temperature ranging from 100° C. to 180° C.

The extruding and foaming of the foamable material can be conducted in any known extrusion apparatus or equipment suitable for this purpose. Preferably, the extruding and foaming of the foamable material is conducted at a temperature ranging from 100° C. to 250° C. More preferably, the extruding and foaming is conducted at a temperature ranging from 100° C. to 220° C.

Optionally, prior to the extruding and foaming of the foamable material, the foamable material is subjected to a drying treatment. In addition, after the extruding and foaming of the foamable material, the foam material thus formed is subjected to a cooling and forming treatment.

The preferred embodiment of an architectural material according to this invention is made from a foam material made by mixing 100 parts by weight of a plastic material with 95 to 105 parts by weight of coal ash and a foaming agent so as to form a foamable material, granulating the foamable material, and extruding and foaming the foamable material. The architectural material includes blind slats, upper and lower beams, a control rod and interlocking elements of a Venetian blind or ventilation louver.

### EXAMPLE

### Preparation of a Foamable Composition

100 parts by weight of PVC, 100 parts by weight of coal ash, 1.2 parts by weight of azodicarbonamide, 1 part by weight of dimethyl tin mercaptide, 7 parts by weight of Kaneace PA40, 0.92 part by weight of calcium stearate and stearic anhydride, 4 parts by weight of titanium dioxide, and 5 parts by weight of calcium carbonate were fed into a high speed mixer and were mixed at a temperature of about 120° C., so as to form a powder foamable material. The power foamable material was then cooled in a cooling tank to a temperature of about 50° C.

The cooled foamable material was then moved to a single-screw extruder and was granulated at a temperature of about 160° C. The temperature was gradually elevated to about 200° C., and the granulate foamable material was extruded and foamed to form a foam plate having a thickness of about 3 mmm.

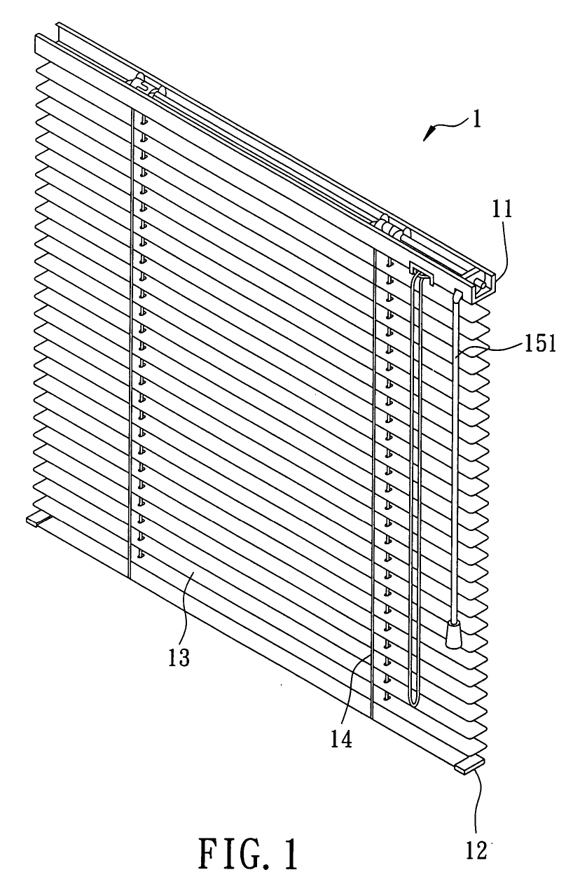

The foam plate thus formed was then machined and processed to form different parts of a Venetian blind 1, as shown in FIG. 1. The parts of the Venetian blind 1 include a upper beam 11, a lower beam 12, a plurality of blind slats 13, retaining cords 14, and a control rod 151.

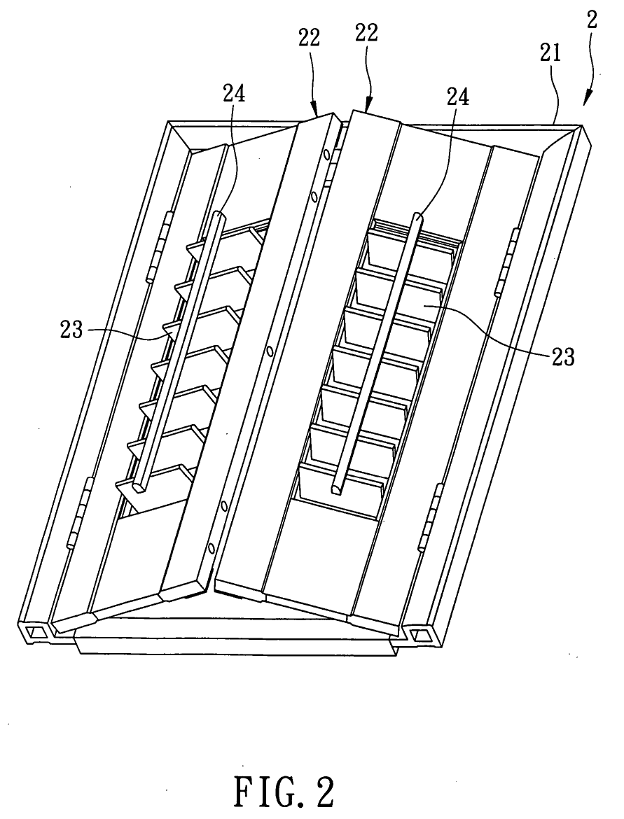

In addition, the foam plate thus formed was also machined and processed to form different parts of a ventilation louver 2, as shown in FIG. 2. The parts of the ventilation louver 2 include a window frame 21, two casements 22 mounted on the window frame 21, and two groups of blind slats 23. Each of the groups of blind slats 23 is mounted on a respective one of the casements 22 through a connecting rod 24. All of the window frame 21, the casements 22, the blind slats 23, and the connecting rods 24 can be made from the foam plate.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A foamable composition, comprising:
100 parts by weight of a plastic material;
4 to 125 parts by weight of coal ash; and
a foaming agent.

2. The foamable composition of claim 1, wherein the plastic material is selected from the group consisting of polyethylene chloride, acrylate-butadiene-styrene copolymer, polystyrene, polyethylene, and combinations thereof.

3. The foamable composition of claim 1, wherein the coal ash has an amount ranging from 95 to 105 parts by weight.

4. The foamable composition of claim 2, wherein the foaming agent has an amount ranging from 0.75 to 1.25 parts by weight.

5. The foamable composition of claim 4, wherein the foaming agent is an azoic foaming agent.

6. The foamable composition of claim 5, wherein the foaming agent is azodicarbonamide.

7. The foamable composition of claim 2, further comprising a stabilizing agent in an amount ranging from 0.5 to 1.75 parts by weight.

8. The foamable composition of claim 7, wherein the stabilizing agent is alkyl tin mercaptide.

9. The foamable composition of claim 8, wherein the stabilizing agent is dimethyl tin mercaptide.

10. The foamable composition of claim 2, further comprising a lubricant in an amount ranging from 0.75 to 1.25 parts by weight.

11. The foamable composition of claim 10, wherein the lubricant is selected from the group consisting of calcium stearate and zinc stearate.

12. The foamable composition of claim 2, further comprising a filler in an amount ranging from 3.0 to 7.0 parts by weight.

13. The foamable composition of claim 12, wherein the filler is calcium carbonate.

14. The foamable composition of claim 2, further comprising a processing aid in an amount ranging from 1.0 to 10.0 parts by weight.

15. The foamable composition of claim 14, wherein the processing aid is an acrylic resin.

16. A method for making a foam material, comprising:
mixing 100 parts by weight of a plastic material with 95 to 105 parts by weight of coal ash and a foaming agent so as to form a foamable material;
granulating the foamable material; and
extruding and foaming the foamable material.

17. The method of claim 16, wherein the mixing of the plastic material with the coal ash and the foaming agent is conducted at a temperature ranging from 105° C. to 145° C.

18. The method of claim 16, wherein the granulating of the foamable material is conducted at a temperature ranging from 100° C. to 180° C.

19. The method of claim 16, wherein the extruding and foaming of the foamable material is conducted at a temperature ranging from 100° C. to 250° C.

20. An architectural material made from a foam material, wherein the foam material is made by mixing 100 parts by weight of a plastic material with 95 to 105 parts by weight of coal ash and a foaming agent so as to form a foamable material, granulating the foamable material, and extruding and foaming the foamable material.
